(19) United States
(12) Patent Application Publication
(10) Pub. No.: US 2014/0177435 A1
(43) Pub. Date: Jun. 26, 2014

(54) WIRELESS TRANSMISSION SYSTEM, WIRELESS TRANSMISSION METHOD, AND WIRELESS COMMUNICATION APPARATUS

(71) Applicants: Hiroaki Miyamoto, Tokyo (JP); Shinichi Morimoto, Tokyo (JP)

(72) Inventors: Hiroaki Miyamoto, Tokyo (JP); Shinichi Morimoto, Tokyo (JP)

(21) Appl. No.: 14/115,845

(22) PCT Filed: May 24, 2012
(86) PCT No.: PCT/JP2012/003397

§ 371 Date: Nov. 5, 2013

(30) Foreign Application Priority Data
May 25, 2011 (JP) 2011-116974

(51) Int. Cl. H04L 12/24

(52) U.S. Cl. CPC H04L 41/0668
USPC 370/221

(57) ABSTRACT

A wireless transmission system includes an active wireless communication apparatus, a standby wireless communication apparatus, and a selecting apparatus for switching an operation. The standby wireless communication apparatus receives a signal transmitted from an opposing apparatus. When the standby wireless communication apparatus detects a failure information indicating that a failure has occurred in the active wireless communication apparatus as a result of reception, the standby wireless communication apparatus performs notification that the failure has occurred in the active wireless communication apparatus. The selecting apparatus that has received the notification performs switch control for switching the operation. Accordingly, it is possible to continue communication in a short switching time in case of a failure while maintaining high frequency utilization, for example.

### TECHNICAL FIELD

The present invention relates to a wireless transmission system, and a wireless transmission method and a wireless communication apparatus that are used in the system, and in particular, to a wireless transmission system, a wireless transmission method, and a wireless communication apparatus including a redundant configuration.

### BACKGROUND ART

In the wireless transmission system for which high communication quality is required, a wireless transmission system with redundancy is introduced to suppress packet loss and packet delay when a failure has occurred in a wireless communication apparatus.

FIG. 8 shows a redundant scheme of a wireless transmission system according to a related art. In the wireless transmission system of FIG. 8, wireless communication is performed between a wireless communication apparatus 810 and a wireless communication apparatus 830, which are active devices, and standby communication is performed between a wireless communication apparatus 820 and a wireless communication apparatus 840, which are standby devices.

In the wireless communication between the wireless communication apparatus 810 and the wireless communication apparatus 830, which are an active system, carriers of frequency f2 and f3 are used for transmission and reception. Further, in the wireless communication between the wireless communication apparatus 820 and the wireless communication apparatus 840, which are a standby system, carriers of other frequency f3 and f4 are used for transmission and reception.

The wireless communication apparatus 810 and the wireless communication apparatus 820 are connected to a selecting apparatus 850. The selecting apparatus 850 has a function to switch the wireless communication apparatus to be connected to a wired network. Similarly, the wireless communication apparatus 830 and the wireless communication apparatus 840 are connected to a selecting apparatus 860. The selecting apparatus 860 has a function to switch the wireless communication apparatus to be connected to a network.

Here, the wireless communication apparatus 820 and the wireless communication apparatus 840, which are standby devices for reducing switching time from the active system to the standby system in case of a failure, are in Hot Standby and performing standby communication using the carriers of the frequency f3 and f4. In case of a communication failure occurring between the wireless communication apparatus 810 and the wireless communication apparatus 830, which are the active devices, the selecting apparatus 850 and the selecting apparatus 860 switch an operation from the active system to the standby system to thereby continue the communication.

For example, Patent Literature 1 discloses the redundancy switch control method as a technique for reducing the switching time from the currently operating active system to the standby system in wired communication. With the control method, in the communication apparatus of the standby system, receive clock synchronization is obtained for a reception line. It is thus possible to perform switching to the standby apparatus in a short switching time even when a failure and the like has occurred in the communication apparatus of the operating system.

### CITATION LIST

### Patent Literature

### Patent Literature 1: Japanese Unexamined Patent Application Publication No. 2009-267953

### SUMMARY OF INVENTION

### Technical Problem

In the wireless transmission system according to a related art, frequency utilization is low because the standby system and the active system use different frequency bands from each other and perform independent communication. Moreover, as both apparatuses in the active system must be switched to the standby system in case of a failure, the standby system must be in Hot Standby in order to reduce the switching time, thus generating a problem of increasing power consumption.

The present invention is made in view of the above issues, and an object of the present invention is to provide a wireless transmission system, a wireless transmission method, and a wireless communication apparatus that are capable of continuing communication in a short switching time while maintaining high frequency utilization in case of a failure, in a wireless transmission system including a redundant configuration.

### Solution to Problem

A wireless transmission system according to the present invention includes: a first wireless communication apparatus and a second wireless communication apparatus including a wireless communication function; and a selecting apparatus that selects the first wireless communication apparatus or the second wireless communication apparatus as a wireless communication apparatus to communicate with an opposing apparatus, in which the opposing apparatus is positioned opposite with a wireless transmission line therebetween. The second wireless communication apparatus receives a signal transmitted from the opposing apparatus when the selecting apparatus selects the first wireless communication apparatus as the wireless communication apparatus to communicate with the opposing apparatus, and performs notification that a failure has occurred in the first wireless communication apparatus when the second wireless communication apparatus detects failure information indicating that the failure has occurred in the first wireless communication apparatus, and the selecting apparatus performs switch control to switch the wireless communication apparatus to communicate with the opposing apparatus from the first wireless communication apparatus to the second wireless communication apparatus based on the notification.

Further, a wireless communication apparatus according to the present invention includes: reception processing means for performing reception processing; receive clock generating means for generating a receive clock; detecting means for detecting that a failure has occurred; and notification means for performing notification that the failure has occurred. When the wireless communication apparatus is not selected as a wireless communication apparatus to communicate with an opposing apparatus by a selecting apparatus that selects a wireless communication apparatus to communicate with the opposing apparatus positioned opposite with a wireless transmission line therebetween, the detecting means detects failure information indicating that a failure has occurred in the wireless communication apparatus communicating with the opposing apparatus from information that has been subjected to the reception processing by the reception processing means. Moreover, the notification means notifies the selecting apparatus, when the failure information is detected, that the failure has occurred in the wireless communication apparatus communicating with the opposing apparatus.

Furthermore, a wireless transmission method according to the present invention includes steps of: selecting, from a plurality of wireless communication apparatuses including a wireless communication function, a wireless communication apparatus to communicate with an opposing apparatus, in which the opposing apparatus is positioned opposite with a wireless transmission line therebetween; receiving, by a wireless communication apparatus not selected as the wireless communication apparatus to communicate with the opposing apparatus, a signal transmitted from the opposing apparatus; detecting failure information in the received signal, in which the failure information indicates that a failure has occurred in the wireless communication apparatus communicating with the opposing apparatus; performing notification when the failure information is detected, in which the notification indicates that the failure has occurred in the wireless communication apparatus communicating with the opposing apparatus; and switching, in response to the notification, the wireless communication apparatus to communicate with the opposing apparatus.

### Advantageous Effects of Invention

According to the present invention, it is possible to provide a wireless transmission system, a wireless transmission method, and a wireless communication apparatus that are capable of continuing communication in a short switching time in case of a failure while maintaining high frequency utilization in a wireless transmission system including a redundant configuration.

### BRIEF DESCRIPTION OF DRAWINGS

FIG. 1 is a block diagram showing a configuration example of a wireless transmission system according to a first exemplary embodiment;

FIG. 2 is a block diagram showing a configuration example of a wireless transmission system according to a second exemplary embodiment;

FIG. 3 is a sequence diagram showing an operation example of switching to a standby system when functions of an active device are completely deactivated during downstream communication according to the second exemplary embodiment;

FIG. 4 is a sequence diagram showing an example of a switching operation to the standby system when the functions of the active device are completely deactivated during upstream communication according to the second exemplary embodiment;

FIG. 5 is a sequence diagram showing an example of a switching operation to the standby system when the functions of the active device are partly deactivated during downstream communication according to the second exemplary embodiment;

FIG. 6 is a sequence diagram showing an example of a switching operation to the standby system when the functions of the active device are partly deactivated during downstream communication according to the second exemplary embodiment;

FIG. 7 is a sequence diagram showing an example of a switching operation to the standby system when the functions of the active device are partly deactivated during upstream communication according to the second exemplary embodiment;

FIG. 8 is a block diagram showing a configuration of a wireless transmission system according to a related art.

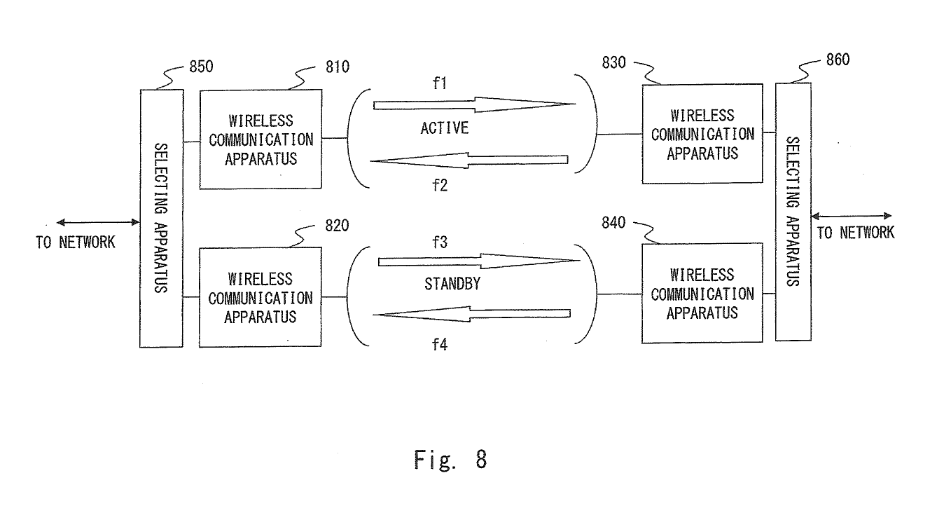

### DESCRIPTION OF EMBODIMENTS

### First Exemplary Embodiment

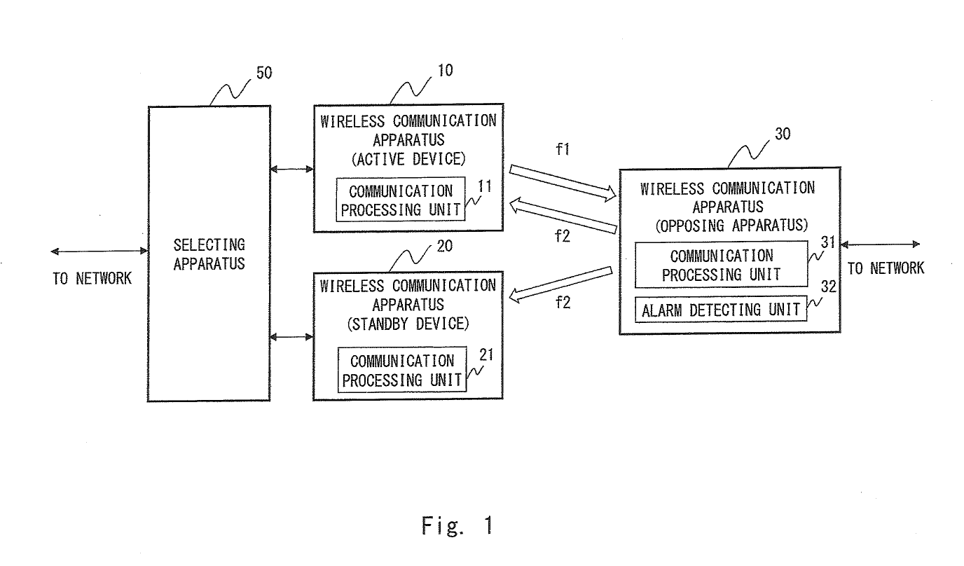

Hereinafter, exemplary embodiments of the present invention are explained with reference to the drawings. FIG. 1 is a block diagram showing a configuration example of a wireless transmission system 1000 according to a first exemplary embodiment of the present invention. In the wireless transmission system 1000, a wireless communication apparatus 10 and a wireless communication apparatus 20 are connected to a selecting apparatus 50. The selecting apparatus 50 is connected to a network by a wired connection. Moreover, the wireless communication apparatus 30 is positioned opposite the wireless communication apparatus 10 and the wireless communication apparatus 20 with a wireless transmission lines therebetween. In the following explanation, the wireless communication apparatus 30 is referred to as an opposing apparatus 30. The wireless transmission system 1000 is explained as FDD (Frequency Division Duplex) that uses a frequency band of frequency f1 in downstream wireless communication and uses a frequency band of frequency f2 in upstream wireless communication.

The selecting apparatus 50 selects the wireless communication apparatus 10 or the wireless communication apparatus 20 as a wireless communication apparatus that wirelessly communicates with the opposing apparatus 30. More specifically, the selecting apparatus 50 includes a switch inside and determines a wireless communication apparatus to operate by connecting the wireless communication apparatus 10 or the wireless communication apparatus 20 to the network.

Data transmitted from the network is transmitted to the wireless communication apparatus selected by the selecting apparatus 50 and wirelessly transmitted from the wireless communication apparatus to the opposing apparatus. Data wirelessly transmitted from the opposing apparatus is received by the wireless communication apparatus selected by the selecting apparatus 50 and transmitted to the network. Note that communication in the present application indicates both transmission and reception. Hereinafter, the wireless communication apparatus selected by the selecting apparatus 50 as the wireless communication apparatus to wirelessly communicate with the opposing apparatus shall be referred to as an active device, and the other wireless communication apparatus provided as a standby shall be referred to as a standby device. In the following explanation, assume that the wireless communication apparatus 10 is the active device, and the wireless communication apparatus 20 is the standby device.

The wireless communication apparatus 10 includes a wireless communication function and wirelessly communicates with the opposing apparatus as the active device. Specifically, the wireless communication apparatus 10 includes a communication processing unit 11. The communication processing unit 11 includes a reception function and a transmission function.

The communication processing unit 11 performs modulation processing on data transmitted from the network via the selecting apparatus 50, superimposes a modulated signal on a carrier having predetermined transmit frequency f1, and transmits the signal to the opposing apparatus 30. Moreover, the communication processing unit 11 receives a signal that is superimposed on the carrier of the transmission frequency f2 and transmitted from the opposing apparatus 30, performs demodulation processing, and transmits demodulated data to the network side.

The wireless communication apparatus 20 includes a wireless communication function as with the wireless communication apparatus 10 and is connected to the selecting apparatus 50 as a standby device. More specifically, the wireless communication apparatus 20 includes a communication processing unit 21. The communication processing unit 21 includes a reception function and a transmission function.

The wireless communication apparatus 20 is the standby device. The wireless communication apparatus 10 is wirelessly communicating with the opposing apparatus 30 as the active device, thus the wireless communication apparatus 20 does not wirelessly communicate with the opposing apparatus 30. More specifically, the communication processing unit 21 deactivates the transmission function thereof and will not wirelessly transmit signals in order to prevent interference in a wireless transmission line.

On the other hand, the wireless communication apparatus 20, even as the standby device, receives the data transmitted from the opposing apparatus 30. That is, in the wireless communication processing unit 21, the transmission function is deactivated but the reception function is activated. Thus, the wireless communication processing unit 21 receives and demodulates the data superimposed on the carrier of the transmission frequency f2 and transmitted from the opposing apparatus 30. The data demodulated by the communication processing unit 21 other than predetermined data is discarded. The predetermined data is, for example, clock recovery information required for reception and failure information indicating that a failure has occurred in the wireless communication apparatus 10.

The opposing apparatus 30 includes a communication processing unit 31 and an alarm detecting unit (a failure detecting unit) 32. The communication processing unit 31 includes a wireless communication function and wirelessly communicates with the wireless communication apparatus 10, which is the active device. The alarm detecting unit 32 monitors a transmission state of the wireless communication apparatus 10, which is the active device, via a reception processing unit inside the communication processing unit 31. The alarm detecting unit 32 detects that a failure has occurred for example when transmission from the wireless communication apparatus 10 suspends, generates failure information indicating that the failure has occurred in the wireless communication apparatus 10, and transmits the failure information to the communication processing unit 31. The communication processing unit 31 wirelessly transmits the failure information received from the alarm detecting unit 32. As mentioned above, the failure information is received by the wireless communication apparatus 20, which is the standby device.

The wireless communication apparatus 20 monitors whether or not the failure information is included in the data received from the opposing apparatus 30. When the failure information is detected in the received data, the wireless communication apparatus 20 notifies the selecting apparatus 50 that the failure has occurred in the wireless communication apparatus 10. In response to the notification from the wireless communication apparatus 20, the selecting apparatus 50 determines that the failure has occurred in the wireless communication apparatus 10 and performs control to switch the active device from the wireless communication apparatus 10 to the wireless communication apparatus 20.

As has been explained, in the wireless transmission system according to the first exemplary embodiment, the wireless communication apparatus 20, which is the standby device, performs reception processing for receiving signals transmitted from the opposing apparatus even when the selecting apparatus selects the wireless communication apparatus 10 as the active device. As a result of the reception processing by the wireless communication apparatus 20, when the wireless communication apparatus 20 receives the failure information indicating that the failure has occurred in the wireless communication apparatus 10, the wireless communication apparatus 20 notifies the selecting apparatus that the failure has occurred in the wireless communication apparatus 10. In response to the notification from the wireless communication apparatus 20, the selecting apparatus 50 performs switch control such that the wireless communication apparatus for wirelessly communicating with the opposing apparatus is switched from the wireless communication apparatus 10 to the wireless communication apparatus 20.

With such a configuration, when a failure has occurred in the active device, the standby device receives failure information transmitted from the opposing apparatus and transmits the failure information to the selecting apparatus, and the selecting apparatus can switch the active device based on the failure information. Accordingly, it is possible to perform switching from an active system to a standby system in a short switching time, thereby preventing packet loss and minimizing packet delay.

### Second Exemplary Embodiment

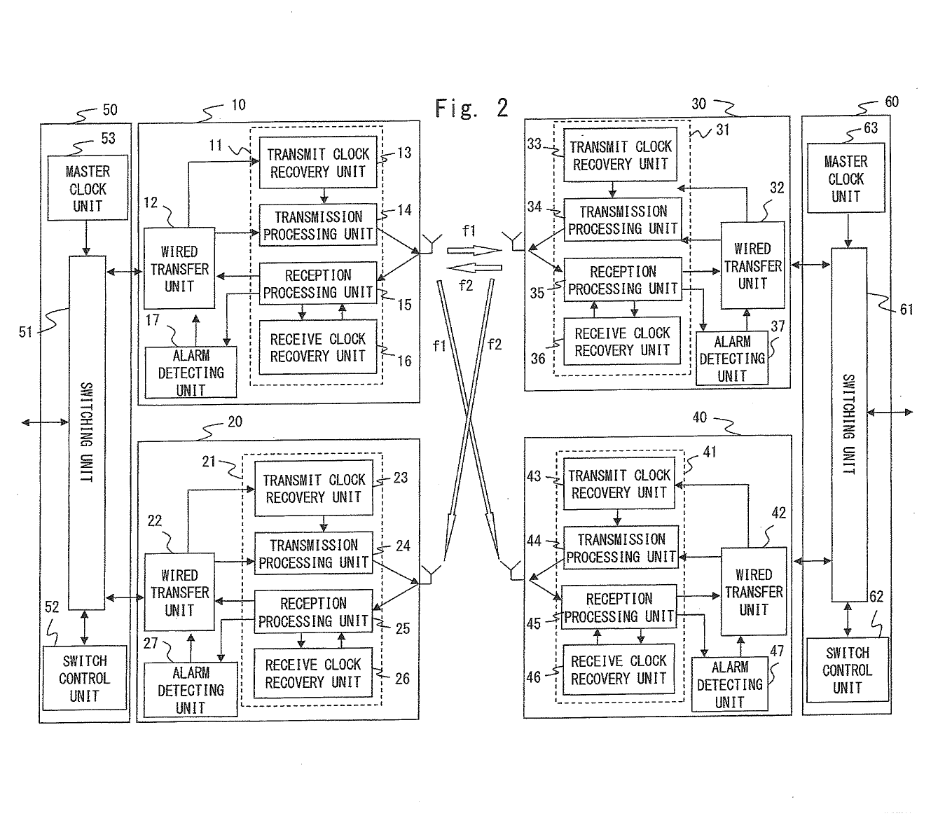

Hereinafter, a second exemplary embodiment of the present invention is explained with reference to the drawings. FIG. 2 is a block diagram showing a configuration example of a wireless transmission system 2000 according to the second exemplary embodiment of the present invention. Each block is explained in detail below. However, the blocks already explained in the first exemplary embodiment shall not be explained here.

Roughly speaking, in this wireless transmission system 2000, the selecting apparatus 50, the wireless communication apparatus 10, and the wireless communication apparatus 20 are arranged on one side, and a selecting apparatus 60, the wireless communication apparatus 30, and a wireless communication apparatus 40 are arranged on the other opposing side with a wireless transmission line therebetween.

The wireless communication apparatus 10 and the wireless communication apparatus 20 are connected to the selecting apparatus 50. The selecting apparatus 50 outputs data transmitted from a wired network side to the wireless communication apparatus 10 or the wireless communication apparatus 20 depending on an operating state. In this exemplary embodiment, assume that the wireless communication apparatus 10 operates as the active device, and the wireless communication apparatus 20 operates as the standby device.

Moreover, on the opposing side, the wireless communication apparatus 30 and the wireless communication apparatus 40 are connected to the selecting apparatus 60. The selecting apparatus 60 outputs data transmitted from a wired network side to the wireless communication apparatus 30 or the wireless communication apparatus 40. In this exemplary embodiment, assume that the wireless communication apparatus 30 operates as the active device, and the wireless communication apparatus 40 operates as the standby device.

That is, the wireless communication apparatus 10 and the wireless communication apparatus 30 wirelessly communicate with each other as the active system, and the wireless communication apparatus 20 and the wireless communication apparatus 40 are arranged as the standby system. Specific configuration of each device is explained below. In the following explanation, the wireless communication apparatus 30, which is the active device on the opposing side, may be referred to as an opposing active device, and the wireless communication apparatus 40, which is the standby device on the opposing side, may be referred to as an opposing standby device.

First, a configuration of the wireless communication apparatus 10 is explained. Roughly speaking, the wireless communication apparatus 10 includes the communication processing unit 11, a wired transfer unit 12, and an alarm detecting unit 17.

The communication processing unit 11 is communication means for wirelessly communicating with the opposing device. Specifically, the communication processing unit 11 includes a transmit clock recovering unit (a transmit clock generating unit) 13, a transmission processing unit 14, a reception processing unit 15, and a receive clock recovering unit (a receive clock generating unit) 16.

The transmit clock recovering unit (the transmit clock generating unit) 13 generates (recovers) a transmit clock required by the transmission processing unit 14 and transmits the transmit clock to the transmission processing unit 14. More specifically, the transmit clock recovering unit 13 receives, from a master clock unit 53 described later, a master clock via a switching unit 51 and the wired transfer unit 12 and phase-locks the master clock to generate (recover) a transmit clock synchronized with the master clock. The transmit clock recovering unit 13 outputs the generated (recovered) transmit clock to the transmission processing unit 14.

Here, the transmit clock recovering unit 13 receives the master clock and generates (recovers) the transmit clock even when the wireless communication apparatus 10 operates as the standby device. With such an operation, even when the wireless communication apparatus 10 is switched from the standby system to the active system, synchronization has already been obtained, thereby eliminating synchronizing processing and reducing the switching time.

The transmission processing unit 14 modulates transmission data transmitted from the wired transfer unit 12 using the transmit clock input from the transmit clock recovering unit 13, superimposes the modulated transmission data on the carrier of the frequency f1, and wirelessly transmits the carrier. The transmission processing unit 14 suspends transmitting the carrier when the wireless communication apparatus 10 operates as the standby device and transmits the carrier when the wireless communication apparatus 10 operates as the active device. When the transmission processing unit 14 receives the failure information, indicating that the failure has occurred in the opposing active device, that is transmitted from the alarm detecting unit 17 via the wired transfer unit 12, the transmission processing unit 14 also modulates the failure information, superimposes the failure information on the carrier of the frequency f1, and wirelessly transmits the carrier.

Using a receive clock input from the receive clock recovering unit 16, the reception processing unit 15 receives a signal transmitted from the opposing wireless communication apparatus 30 or the opposing wireless communication apparatus 40 and then demodulates the signal. From the data that has been subjected to the reception processing, the reception processing unit 15 transmits clock recovery information necessary for reception to the receive clock recovering unit 16, transmits the failure information to the alarm detecting unit 17, and transmits other demodulated data to the wired transfer unit 12.

Moreover, the reception processing unit 15 monitors signals transmitted from the wireless communication apparatus 30, which is the opposing active device. When transmission of the carrier of the frequency f2 stops, which is the transmission frequency in the opposing active device, or upon detection of an abnormality in the opposing active device from data such as the demodulated data, the reception processing unit 15 transmits, to the alarm detecting unit 17, a signal indicating that the abnormality has occurred in the opposing active device.

Here, the reception processing unit 15 operates at any time even when the wireless communication apparatus 10 is operating as the standby device and obtains data by the reception processing and the demodulation processing. While the reception processing unit 15 is performing the reception processing and the demodulation processing as the standby device, when the obtained data includes the failure information indicating that the failure has occurred in the wireless communication apparatus 20, which is the active device, the reception processing unit 15 transmits the failure information to the alarm detecting unit 17.

The receive clock recovering unit (the receive clock generating unit) 16 inputs the clock recovery information, which is the information required for the reception processing, from the reception processing unit 15, and generates (recovers) the receive clock using the clock recovery information. The receive clock recovering unit 16 outputs the generated receive clock to the reception processing unit 15. Here, even when the wireless communication apparatus 10 operates as the standby device, the receive clock recovering unit 16 generates (recovers) the receive clock based on the clock recovery information and outputs the receive clock to the reception processing unit 15.

The alarm detecting unit 17 detects an inside alarm, which is a failure in the own device, generates failure information indicating detection of the inside alarm, and transmits the failure information to the wired transfer unit 12. Moreover, the alarm detecting unit 17 receives, from the reception processing unit 15, a signal indicating that an abnormality has occurred in the opposing active device and detects the abnormality in the opposing active device. The alarm detecting unit 17 generates the failure information indicating that the abnormality has been detected in the opposing active device and transmits the failure information to the wired transfer unit 12. When the wireless communication apparatus 10 operates as the standby device, the alarm detecting unit 17 detects failure information, indicating that a failure has occurred in the wireless communication apparatus 20 which is the active device, that is transmitted from the opposing active device and transmits the failure information to the wired transfer unit 12.

The wired transfer unit 12 is connected to the switching unit 51 of the selecting apparatus 50 and transmits data received from each block to appropriate blocks. More specifically, the wired transfer unit 12 transmits data received from the switching unit 51 to the transmission processing unit 14 and transmits data received from the reception processing unit 15 to the switching unit 51. Moreover, the wired transfer unit 12 transmits, to the transmit clock recovering unit 13, the master clock input from the master clock unit 53 via the switching unit 51. Further, the wired transfer unit 12 transfers the failure information, received from the alarm detecting unit 17, indicating that the failure has occurred in the wireless communication apparatus 10 or the wireless communication apparatus 20, to a switching control unit 52 via the switching unit 51, to thereby notify that the failure has occurred in the wireless communication apparatus. The wired transfer unit 12 transfers, to the transmission processing unit 14, the failure information, indicating that the abnormality has occurred in the opposing active device, that is received from the alarm detecting unit 17 so as to notify the switch control unit 52 that the failure has occurred in the opposing active device.

Note that the wireless communication apparatuses 20, 30, and 40 have the same configuration as the wireless communication apparatus 10, thus the explanation shall not be provided here. These wireless communication apparatuses can operate as the active device or the standby device and operate as the active device or the standby device according to switch control performed by the selecting apparatus. Even when the wireless communication apparatuses operate as the standby devices, these wireless communication apparatuses receive information wirelessly transmitted from the opposing active device and monitor whether or not a failure has occurred in the active device. Moreover, in the wireless communication apparatus operating as the standby device, the wired transfer unit inputs the master clock that is referred by the active device and outputs the input master clock to the transmit clock recovering unit. The transmit clock recovering unit generates (recovers) the transmit clock that is synchronized with the input master clock. Accordingly, even when the wireless communication apparatus is suddenly switched from the standby device to operate as the active device, the wireless communication apparatus can start processing for starting an operation from the state where transmission clock synchronization is obtained. This reduces the switching time from the standby system to the active device and minimizes packet delay.

Next, the selecting apparatus is explained. The selecting apparatus 50 includes the switching unit 51, the switch control unit 52, and the master clock unit 53.

The switching unit 51 selects the wireless communication apparatus 10 or the wireless communication apparatus 20 as a wireless communication apparatus for wirelessly communicating with the wireless communication apparatus 30, which is the opposing active device, according to switch control by the switch control unit 52 described later. The switching unit 51 transmits data transmitted from the wired network to the wireless communication apparatus and transfers the data transmitted from the wireless communication apparatus to the wired network. Further, the switching unit 51 transmits, to the switch control unit 52, the failure information that is detected by the alarm detecting unit 17 or an alarm detecting unit 27 and transmitted via the wired transfer unit 12 or a wired transfer unit 22.

The switch control unit 52 controls a connection destination of the switching unit 51. More specifically, the switch control unit 52 outputs a control signal to the switching unit 51. The control signal indicates whether the data from the wired network is passed to the wired transfer unit 12 or the wired transfer unit 22. In response to the failure information from the switching unit 51, the switch control unit 52 outputs, to the switching unit 51, a switch control signal for switching the active device. Further, to switch the operation, the switch control unit 52 outputs an operation start control signal via the switching unit 51 to the transmission processing unit of the wireless communication apparatus that is switched as a new active device in order to activate the transmission processing unit that has been deactivated as the standby device. In response to the operation start control signal, the transmission processing unit activates the deactivated the transmission function.

The master clock unit 53 generates the master clock, which is a reference clock signal. The generated master clock is transmitted to the wireless communication apparatus 10 and the wireless communication apparatus 20 and is referred when the transmit clock recovering unit 13 and the transmit clock recovering unit 23 of the wireless communication apparatus 20 generate (recover) the transmit clock. As both the active device and the standby device generate the transmit clock based on the common master clock, the transmit clock of the active device and the transmit clock of the standby device are synchronized.

The configuration of the selecting apparatus 60 is the same as that of the selecting apparatus 50, thus the explanation shall not be provided here.

As explained above, in the wireless transmission system of this exemplary embodiment, the alarm detecting unit of the opposing active device monitors the transmission state of the active device via the reception processing unit. The alarm detecting unit detects a failure, for example when transmission from the active device stops, and generates failure information. The transmission processing unit wirelessly transmits the failure information to the standby device. The standby device recovers the receive clock at any time and receives the data wirelessly transmitted from the opposing active device, thus the standby device can detect not only a failure generated in the own device but also a failure generated in the active device based on failure information received from corresponding device.

That is, in the standby device, the reception processing unit and the receive clock generating unit operate at any time and demodulates the data wirelessly transmitted from the opposing active device, thereby reducing the switching time to the standby device in case of a failure in the active device. Accordingly, even when the active device detects a failure in the own active device but unable to notify the switch control unit of failure information, the switch control unit can obtain failure information via the opposing active device and the standby device, thereby enabling a switch in a short time.

Moreover, the wireless transmission system of this exemplary embodiment is configured such that both the active device and the standby device synchronize the receive clock by the transmit clock recovering unit. That is, the transmit clock recovering unit in the active device and the standby system phase-lock the common master clock to generate (recover) the transmit clock, thus the clock synchronization is obtained.

As described above, by including, in the standby device, a circuit for smoothly performing switch to the standby device, it is possible to operate the standby device at the same frequency as the frequency for the active device, prevent packet loss in switch to the standby device, and minimize packet delay in switch to the standby device.

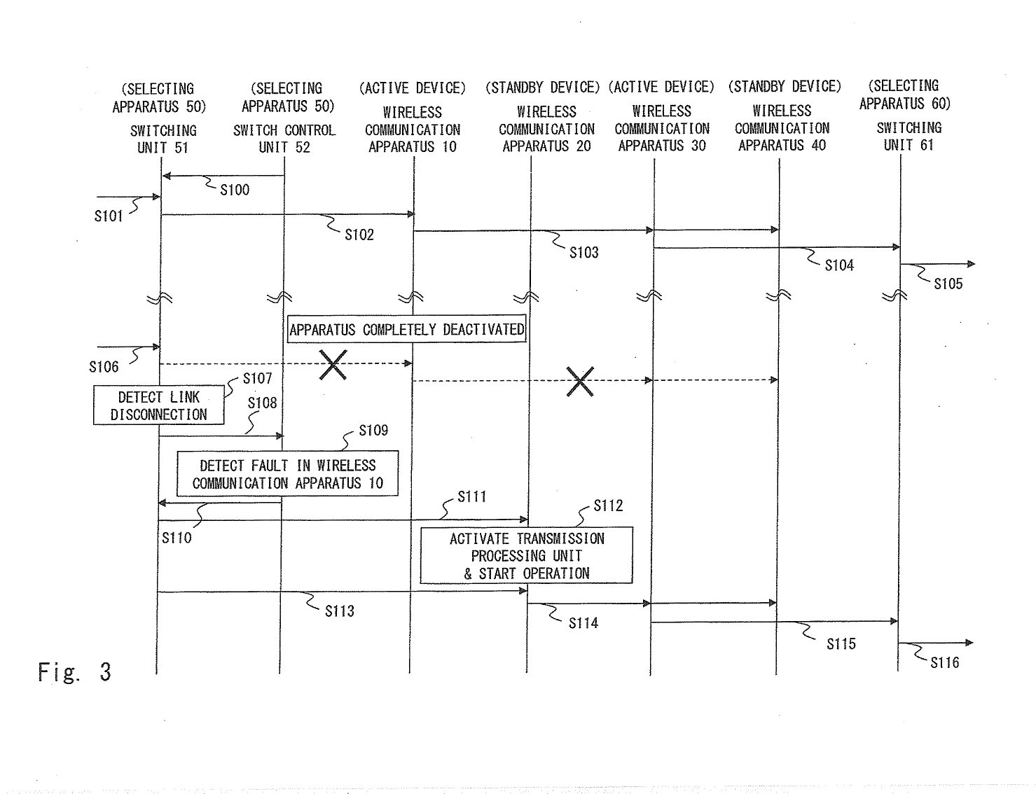

Next, an operation of the wireless transfer system 2000 in case of a failure is explained using the drawings. Explained below is each of various cases of failures that can be assumed to occur in the wireless transfer system 2000 using FIGS. 3 to 7. Hereinafter, communication from the wireless communication apparatus 10 side to the wireless communication apparatus 30 side shall be referred to as downstream, and communication in the opposite direction shall be referred to as upstream.

FIG. 3 is a sequence diagram showing an example of a switching operation from the active system to the standby system when a failure such as power disconnection has occurred in the wireless communication apparatus 10, which is the active device, during downstream communication, and the functions of the wireless communication apparatus 10 are completely deactivated.

The switch control unit 52 outputs, to the switching unit 51, a control signal indicating selection of the wireless communication apparatus 10 as the active device (Step S100). The switching unit 51 selects the wireless communication apparatus 10 as the wireless communication apparatus to wirelessly communicate with the opposing apparatus according to the control signal from the switch control unit 52 in Step S100 and connects the wired network with the wireless communication apparatus 10.

Next, the switching unit 51 receives data transmitted from the wired network side (Step S101). The switching unit 51 transmits the data received from the wired network side in Step S101 to the wireless communication apparatus 10 that is selected as the active device (Step S102). The wireless communication apparatus 10 performs the modulation processing and the transmission processing on the data received from the switching unit 51, superimposes the data on a predetermined carrier, and wirelessly transmits the carrier (Step S103). The data transmitted from the wireless communication apparatus 10 is received by both the wireless communication apparatus 30, which is the active device on the opposing side, and the wireless communication apparatus 40, which is the standby device on the opposing side.

The wireless communication apparatus 30, which is the active device on the opposing side, receives the data transmitted in Step S103, and transmits the data that has been subjected to the reception processing and the demodulation processing to a switching unit 61 (Step S104). On the other hand, the wireless communication apparatus 40, which is the standby device, performs the reception processing and the demodulation processing on the data received in Step S103 but will not transmit the demodulated data to the switching unit 61 and discards the data as necessary.

The switching unit 61 transmits the data received from the wireless communication apparatus 30 to the wired network side (Step S105).

Downstream communication continues by repeating the operation from the above Steps S101 to S105.

Here, suppose that a failure has occurred in the wireless communication apparatus 10, such as disconnection of power supply, and functions of the apparatus are completely deactivated. In such a case, all the functions of the wireless communication apparatus 10 are deactivated, thus the connection is interrupted between the switching unit 51 of the selecting apparatus 50 and the wired transfer unit 12 of the wireless communication apparatus 10.

When the switching unit 51 receives new data from the network side in this state (Step S106), the switching unit 51 is unable to transmit the data to the wireless communication apparatus 10 as the connection with the wireless communication apparatus 10, which is the active device, is interrupted. Here, the switching unit 51 detects that the connection with the wireless communication apparatus 10 is interrupted by a link state detecting unit included inside that is not shown in the drawings (Step S107). More specifically, the link state detecting unit monitors a connection state of the wireless communication apparatus that is connected to the switching unit 51. When a response from the wireless transfer unit 12 is interrupted, the link state detecting unit determines that the connection with the wireless communication apparatus 10 is interrupted. When the link state detecting unit detects that the connection is interrupted in Step S107, the link state detecting unit notifies the switch control unit 52 that the connection with the wireless communication apparatus 10 is interrupted (Step S108).

With the notification from the link state detecting unit, the switch control unit 52 detects that an abnormality such as a fault has occurred in the wireless communication apparatus 10 (Step S109). When the switch control unit 52 detects that the abnormality has occurred in the wireless communicating apparatus 10, the switch control unit 52 performs switch control to switch the active device from the wireless communication apparatus 10 to the wireless communication apparatus 20 (Step S110). More specifically, the switch control unit 52 outputs, to the switching unit 51, a switch control signal indicating switch of a connection destination of the wired network from the wireless communication apparatus 10 to the wireless communication apparatus 20. The active system and the standby system are switched by the control performed by the switch control unit 52.

In response to the switch signal, the switching unit 51 switches the connection destination of the wired network to the wireless communication apparatus 20 while transmitting, to the wireless communication apparatus 20, the operation start control signal, which is a control signal for activating the transmission function (Step S111).

The wireless communication apparatus 20 activates the transmission processing unit 24 based on the operation start control signal transmitted from the switching unit 51 and starts an operation (Step S12).

After that, the switching unit 51 transmits the data transmitted from the wired network to the wireless communication apparatus 20 that is switched as the active device (Step S113). The wireless communication apparatus 20 performs the modulation processing and the transmission processing on the data received from the switching unit 51, superimposes the data on the carrier of the frequency f1, and wirelessly transmits the carrier (Step S114). The data wirelessly transmitted from the wireless communication apparatus 20 is also received by both the wireless communication apparatus 30, which is the active device on the opposing side, and the wireless communication apparatus 40, which is the standby device on the opposing side.

The wireless communication apparatus 30 transmits the data received in Step S114 to the switching unit 61 (Step S115). On the other hand, the wireless communication apparatus 40, which is the standby device, performs the reception processing and the demodulation processing on the data received in Step S114 and obtains the data but will not transmit the data to the switching unit 61 and discards the data as necessary.

The switching unit 61 transmits the data received from the wireless communication apparatus 30 to the wired network side (Step S117).

As described so far, when the functions of the wireless communication apparatus 10, which is the active device, are completely deactivated, the link state detecting means provided inside the selecting apparatus detects that an abnormality has occurred in the active device and the operation is switched. With such a configuration, it is possible to reduce the time taken for switch and minimizes packet loss and packet delay.

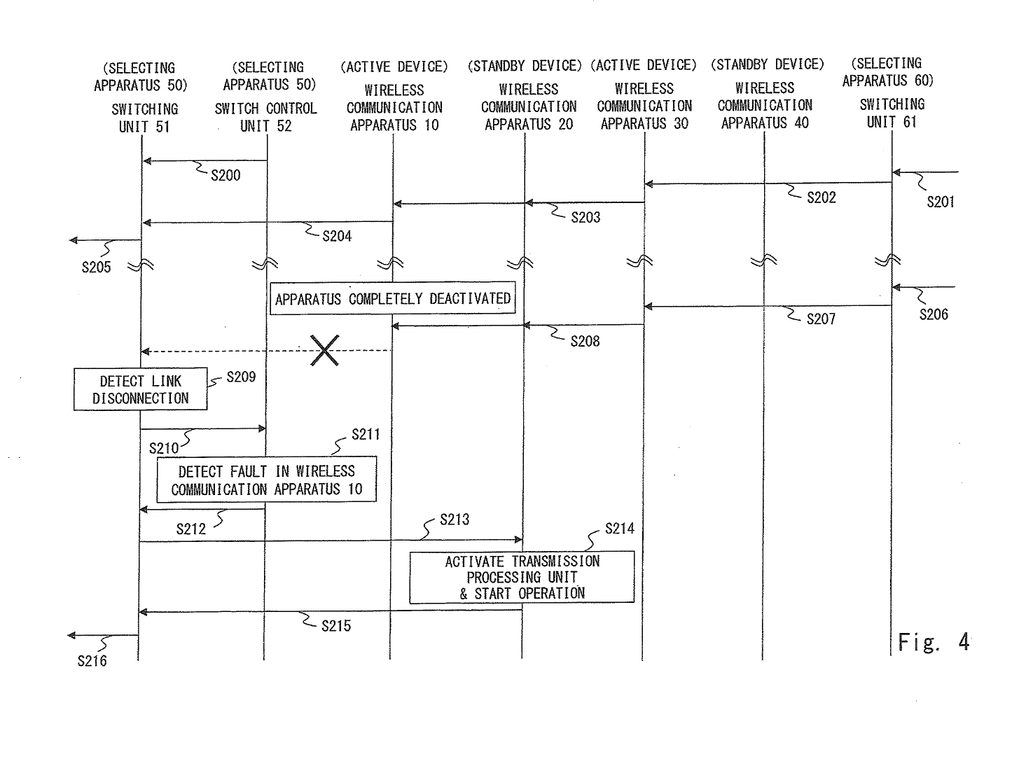

Next, a case is explained in which a failure has occurred during upstream data communication. FIG. 4 is a sequence diagram showing an example of a switching operation from the active system to the standby system when a failure such as power disconnection has occurred in the wireless communication apparatus 10, which is the active device, during upstream communication, and the functions of the wireless communication apparatus 10 are completely deactivated.

In a similar manner to FIG. 3, the switch control unit 52 outputs a control signal indicating selection of the wireless communication apparatus 10 as the active device, and then the switching unit 51 connects the wired network to the wireless communication apparatus 10 (Step S200). Also on the opposing side, suppose that the switching unit 61 of the selecting apparatus 60 selects the wireless communication apparatus 30 as the active device, and the wired network and the wireless communication apparatus 30 are connected.

The switching unit 61 receives data transmitted from the wired network side (Step S201). The switching unit 61 transmits the data transmitted from the wired network to the wireless communication apparatus 30 that is selected as the active device (Step S202).

The wireless communication apparatus 30 performs the modulation processing and the transmission processing on the data received from the switching unit 61, superimposes the data on a predetermined carrier, and wirelessly transmits the carrier (Step S203). The data transmitted from the wireless communication apparatus 30 is received by both the wireless communication apparatus 10, which is the active device, and the wireless communication apparatus 20, which is the standby device.

The wireless communication apparatus 10, which is the active device, receives the data transmitted from the wireless communication apparatus 30 in Step S203, performs demodulation processing, and transmits the data to the switching unit 51 (Step S204). On the other hand, the wireless communication apparatus 20, which is the standby device, receives the data transmitted from the wireless communication apparatus 30 in Step S203 and performs the reception processing and the demodulation processing but will not transmit the data to the switching unit 51 and discards the data as necessary.

The switching unit 51 transmits the data received from the wireless communication apparatus 10 to the wired network side (Step S205).

Upstream communication continues by repeating the operation from above Steps S201 to S205.

Here, suppose that a failure such as a power disconnection has occurred in the wireless communication apparatus 10, and the functions of the apparatus are completely deactivated. In such a case, all the functions of the wireless communication apparatus 10 are deactivated, thus the connection of the switching unit 51 and the wired transfer unit 12 is interrupted.

After that, when the data is transmitted from the network side, the switching unit 61 receives the data (Step S206) and transmits the data to the wireless communication apparatus 30, which is the active device (Step S207).

The wireless communication apparatus 30 wirelessly transmits the data received from the switching unit 61 (Step S208). As all the functions of the wireless communication apparatus 10 are deactivated, the wireless communication apparatus 10 is unable to receive the data wirelessly transmitted from the wireless communication apparatus 30. On the other hand, after the wireless communication apparatus 20, which is the standby device, receives the data, and performs the reception processing and the demodulation processing, the wireless communication apparatus 20 discards the data as necessary.

Here, in a similar manner to FIG. 3, the switching unit 51 monitors the connection state of the wireless communication apparatus 10 by the link state detecting unit inside and detects that the connection with the wireless communication apparatus 10 is interrupted when the functions of the wireless communication apparatus 10 are completely deactivated (Step S209). When the link state detecting unit detects that the connection is interrupted in Step S209, the link state detecting unit notifies the switch control unit 52 that the connection with the wireless communication apparatus 10 is interrupted (Step S210).

With the notification from the link state detecting unit, the switch control unit 52 detects that an abnormality has occurred in the wireless communication apparatus 10 (Step S211). When the switch control unit 52 detects that the abnormality has occurred in the wireless communication apparatus 10, the switch control unit 52 performs control to switch the active device from the wireless communication apparatus 10 to the wireless communication apparatus 20 (Step S212). More specifically, the switch control unit 52 outputs, to the switching unit 51, a switch signal indicating switch of a connection destination of the wired network from the wireless communication apparatus 10 to the wireless communication apparatus 20.

In response to the switch signal, the switching unit 51 switches the connection destination of the wired network to the wireless communication apparatus 20 while transmitting, to the wireless communication apparatus 20, the operation start control signal, which is a control signal for activating the transmission processing unit 24 (Step S213). The wireless communication apparatus 20 activates the transmission processing unit 24 based on the operation start control signal transmitted from the switching unit 51 and starts an operation (Step S214).

After the wireless communication apparatus 20 is switched as the wireless communication apparatus for wirelessly communicating with the opposing apparatus, the wireless communication apparatus 20 will not discard the data received from the wireless communication apparatus 30 and transmits the data to the switching unit 51 (Step S215). The switching unit 51 transmits the data received from the wireless communication apparatus 20 to the wired network side (Step S216).

As described above, when the functions of the wireless communication apparatus 10, which is the active device, are completely deactivated during the upstream communication, the link state detecting means provided inside the selecting apparatus can detect the abnormality and the operation can be switched. Therefore, before the wireless communication apparatus 20, which is the standby device, discards the demodulated data in Step S208, processing from Steps S209 to S212 is performed and the standby device is switched to the active device, thereby preventing packet loss from being generated.

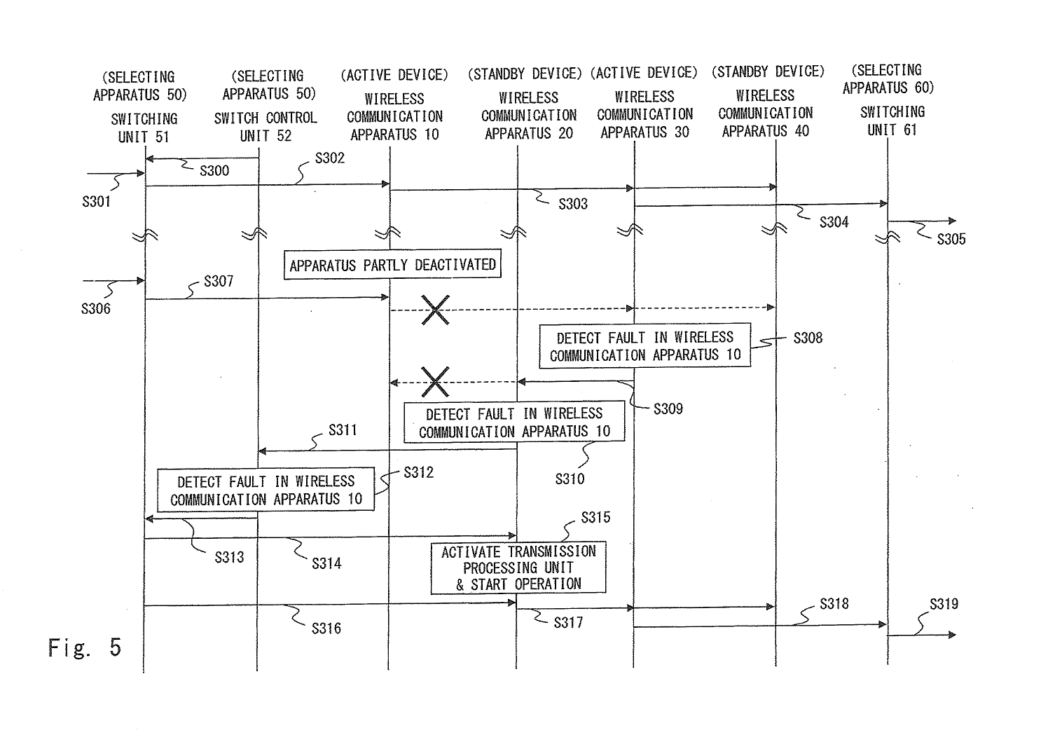

Explained below is failure detection when a part of the functions of the wireless communication apparatus 10 is deactivated. FIG. 5 is a sequence diagram showing an example of a switching operation from the active system to the standby system when the communication function of the communication processing unit 11, which is a part of the functions of the wireless communication apparatus 10, is deactivated in the wireless communication apparatus 10, which is the active device, during downstream communication. Note that Steps S300 to S305 are the same as Steps S100 to S105 of FIG. 3, thus the explanation shall not be provided here.

Suppose that the communication function of the wireless communication apparatus 10 is deactivated at a certain point during downstream communication. In such a case, the function of the wired transfer unit 12 of the wireless communication apparatus 10 is not deactivated, thus the connection with the switching unit 51 is maintained and the link state detecting unit will not detect a disconnection. When the switching unit 51 receives new data from the network side (Step S306), the switching unit 51 transmits the data to the wireless communication apparatus 10 (Step S307).

Here, since the communication function of the wireless communication apparatus 10 is deactivated, the wireless communication apparatus 10 is unable to wirelessly transmit the data received from the switching unit 51. The wireless communication apparatus 30, which is the active device on the opposing side, is unable to receive the data from the wireless communication apparatus 10, thus the wireless communication apparatus 30 detects that a failure such as a fault has occurred in the wireless communication apparatus 10 (Step S308). More specifically, when an alarm detecting unit 37 of the wireless communication apparatus 30 is unable to receive, for a certain time, data from the wireless communication apparatus 10 that is communicating with a reception processing unit 35, the alarm detecting unit 37 detects that the failure has occurred in the wireless communication apparatus 10 and generates failure information indicating that the failure has occurred in the wireless communication apparatus 10.

The wireless communication apparatus 30 wirelessly transmits the failure information generated by the alarm detection unit 37 (Step S309). The failure information wirelessly transmitted from the wireless communication apparatus 30 is received by the wireless communication apparatus 20, which is the standby device. On the other hand, as the communication function is deactivated, the wireless communication apparatus 10 is unable to receive the failure information.

In the wireless communication apparatus 20, the alarm detecting unit 27 monitors the data that has been subjected to the reception processing and the demodulation processing by the reception processing unit 25. When the failure information is included in the data, the alarm detecting unit 27 detects that some sort of failure such as a fault has occurred in the wireless communication apparatus 10, which is the active device, based on the failure information (Step S310). The wireless communication apparatus 20 transmits, to the switching control unit 52 via the switching unit 51, the failure information, indicating that the failure has occurred in the wireless communication apparatus 10, that is detected by the alarm detecting unit 27 (Step S311).

The switch control unit 52 detects that the abnormality has occurred in the wireless communication apparatus 10 by receiving the above-mentioned failure information from the wireless communication apparatus 20 (Step S312).

Note that the subsequent Steps S313 to S319 are the same as Steps S110 to S116 of FIG. 3, thus the explanation shall not be provided here.

As explained above, when a part of the functions such as the communication function is deactivated in the wireless communication apparatus 10, which is the active device, the selecting apparatus 50 is unable detect a failure occurred in the wireless communication apparatus 10. However, in the wireless transmission system 2000 of the present invention, the opposing apparatus detects the failure and wirelessly transmits the failure information. Then, the wireless communication apparatus 20, which is the standby device, receives the failure information to thereby detect that the failure has occurred in the wireless communication apparatus 10. Accordingly, the selecting apparatus 50 that has received the failure information from the wireless communication apparatus 20 can appropriately perform switch from the active system to the standby system.

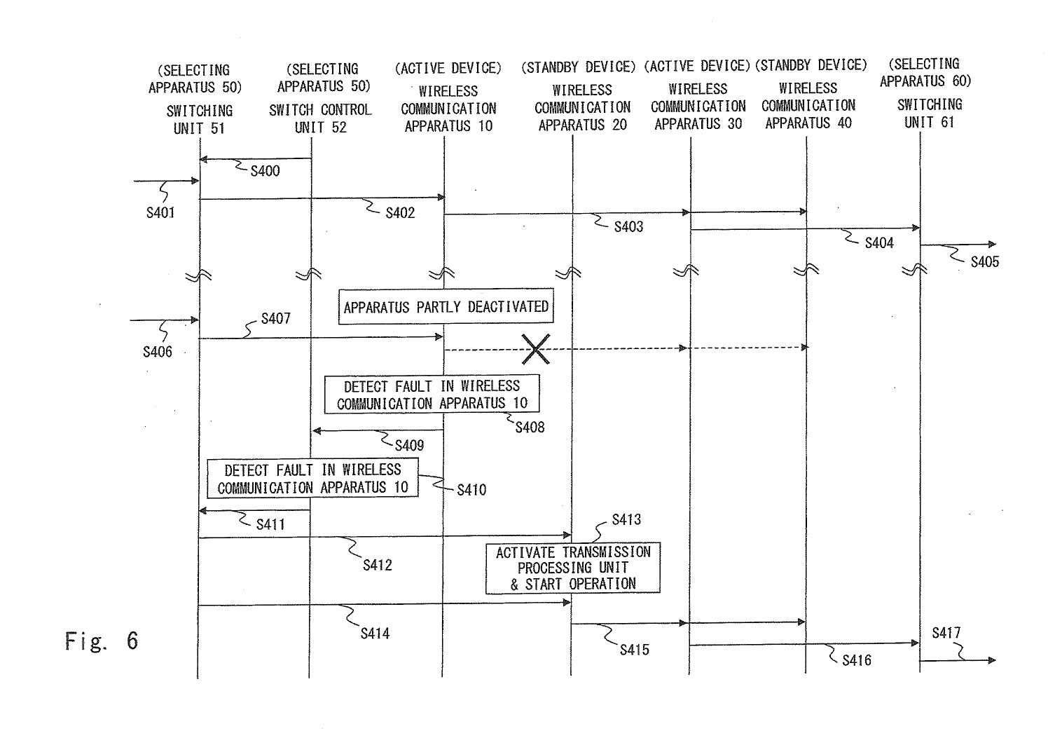

Next, in a similar manner to FIG. 5, another failure detecting method is explained when a part of the functions of the wireless communication apparatus 10 is deactivated. FIG. 6 is a sequence diagram showing an example of a switching operation from the active system to the standby system when the communication function of the communication processing unit 11, which is a part of the functions of the wireless communication apparatus 10, is deactivated in the wireless communication apparatus 10, which is the active device, during downstream communication. Note that Steps S400 to S407 are the same as Steps S300 to S307 of FIG. 5, thus the explanation shall not be provided here.

Since the communication function of the wireless communication apparatus 10 that has received the data from the switching unit 51 in Step S407 is deactivated, the data cannot be wirelessly transmitted. The alarm detecting unit 17 of the wireless communication apparatus 10 monitors the state of the wireless communication apparatus 10 and detects a failure in the wireless communication apparatus 10 when an abnormality has occurred (Step S408). More specifically, the alarm detecting unit 17 monitors each unit inside the apparatus such as the communication processing unit 11. When the alarm detecting unit 17 detects that the failure and the like has occurred in the communication function of the communication processing unit 11, the alarm detecting unit 17 generates failure information indicating that the failure has occurred in the wireless communication apparatus 10.

The failure information generated by the alarm detecting unit 17 is transmitted to the switch control unit 52 via the switching unit 51 (Step S409). The switch control unit 52 detects that the failure has occurred in the wireless communication apparatus 10 based on the above-mentioned failure information that is transmitted from the alarm detecting unit 17 (Step S410).

Note that Steps S411 to S417 are same as Steps S313 to S319 of FIG. 5, thus the explanation shall not be provided here.

As explained above, even when a part of the functions of the wireless communication apparatus 10, which is the active device, is deactivated, if the alarm detecting unit 17 included inside detects a failure, the wireless communication apparatus 10 itself can transmit failure information to the selecting apparatus 50. Therefore, the selecting apparatus 50 that has received the failure information from the wireless communication apparatus 10 can perform switch from the active system to the standby system.

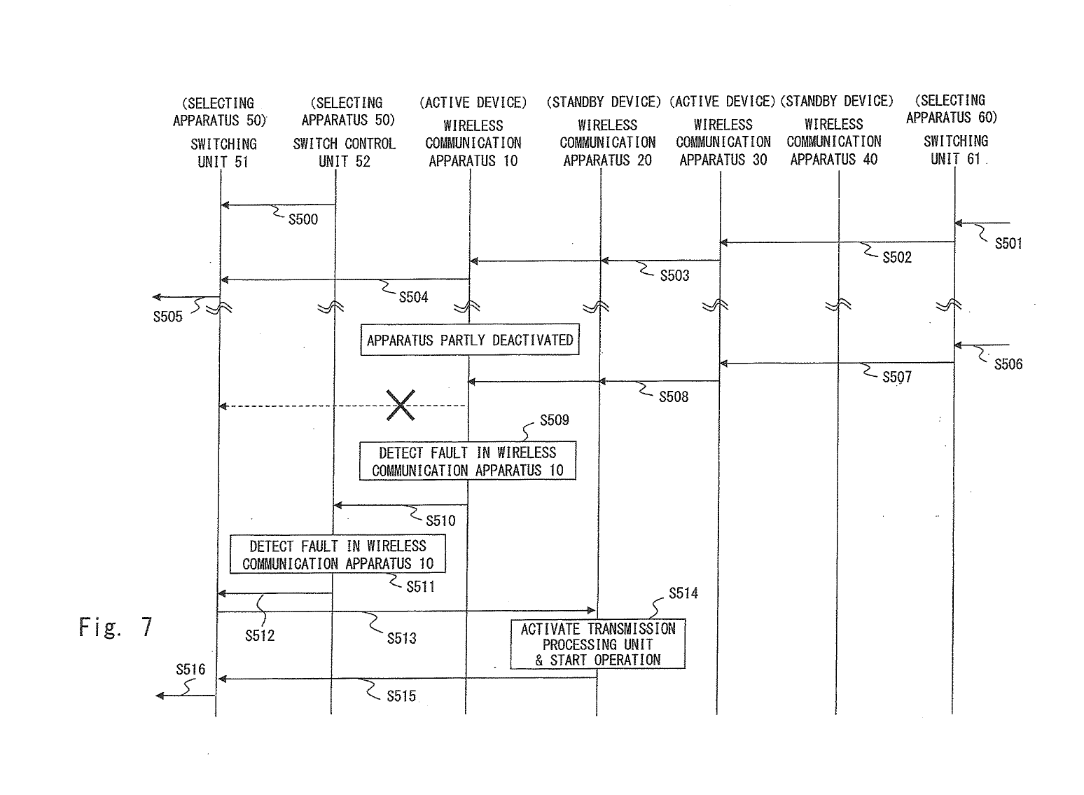

Next, a failure detecting method is explained when a part of the functions of the wireless communication apparatus 10 is deactivated during upstream data communication. FIG. 7 is a sequence diagram showing an example of switching operation from the active system to the standby system when the communication function of the communication processing unit 11, which is a part of the functions of the wireless communication apparatus 10, is deactivated in the wireless communication apparatus 10, which is the active device, during upstream communication. Note that Steps S500 to S508 are the same as Steps S200 to S208 of FIG. 4, thus the explanation shall not be provided here.

Since the function of the wired transfer unit 12 is not deactivated even when the communication function of the wireless communication apparatus 10 is deactivated, the link state detecting unit provided inside the switching unit 51 will not detect a failure in the wireless communication apparatus 10. On the other hand, the alarm detecting unit 17 provided inside the wireless communication apparatus 10 monitors the state of the wireless communication apparatus 10. When an abnormality has occurred, the alarm detecting unit 17 detects the failure as a failure in the wireless communication apparatus 10 (Step S509). More specifically, the alarm detecting unit 17 monitors the communication processing unit 11. When the alarm detecting unit 17 detects that a fault and the like has occurred in the communication function of the communication processing unit 11, the alarm detecting unit 17 generates failure information indicating that the failure has occurred in the wireless communication apparatus 10.

The failure information generated by the alarm detecting unit 17 is transmitted to the switch control unit 52 via the switching unit 51 (Step S510). The switch control unit 52 detects that the failure has occurred in the wireless communication apparatus 10 based on the above-mentioned failure information that is transmitted from the alarm detecting unit 17 (Step S511).

Note that Steps S512 to S516 are the same as Steps S212 to S216 of FIG. 4, thus the explanation shall not be provided here.

As explained above, even when the communication function is deactivated in the wireless communication apparatus 10 during upstream communication, the wireless communication apparatus 10 detects a failure occurred in the wireless communication apparatus 10 and transmits failure information to the selecting apparatus. Accordingly, the selecting apparatus can perform switch from the active system to the standby system based on the failure information.

As explained in the above exemplary embodiments, the wireless transmission system of the present invention has a redundant configuration including the active system and the standby system. In the standby device, the reception function and the receive clock recovering function operate, and in a similar manner to the active device, the standby device receives data that is wirelessly transmitted from the opposing active device. Accordingly, it is possible to continue the reception processing even when the operation is changed and the standby device is switched to the active device.

Moreover, in the standby device, the transmit clock recovering unit inputs the master clock that is referred by the active device and phase-locks the master clock to thereby generate (recover) the transmit clock even as the standby device. As the standby device has already generated the transmit clock, which relatively takes time, even when the operation has switched from the active system to the standby system, the standby device can start the transmission processing smoothly.

Note that the case is explained above in which one wireless communication apparatus is included as the standby device, it is not limited to this. A configuration may be employed in which two or more wireless communication apparatuses are connected to the selecting apparatus as the standby devices.

Further, each function in the wireless communication apparatus and the selecting apparatus may be achieved through execution of a program by a Central Processing Unit (CPU) not shown in the drawings.

In short, the present invention has been explained as a hardware configuration, however the present invention is not limited thereto. The present invention can be realized by causing a CPU to execute a computer program. The above-mentioned program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Note that the present invention is not limited to the above configuration but various modifications can be made without departing from the scope. For example, following configurations can be employed.

(1) A wireless transmission system comprising:

a first wireless communication apparatus and a second wireless communication apparatus including a wireless communication function; and

a selecting apparatus that selects the first wireless communication apparatus or the second wireless communication apparatus as a wireless communication apparatus to communicate with an opposing apparatus, the opposing apparatus being positioned opposite with a wireless transmission line therebetween, wherein

the second wireless communication apparatus
receives a signal transmitted from the opposing apparatus when the selecting apparatus selects the first wireless communication apparatus as the wireless communication apparatus to communicate with the opposing apparatus, and
performs notification that a failure has occurred in the first wireless communication apparatus when the second wireless communication apparatus detects failure information indicating that the failure has occurred in the first wireless communication apparatus, and the selecting apparatus performs switch control to switch the wireless communication apparatus to communicate with the opposing apparatus from the first wireless communication apparatus to the second wireless communication apparatus based on the notification.
   (2) The wireless transmission system according to (1), wherein

between the first wireless communication apparatus and the second wireless communication apparatus,
the wireless communication apparatus selected as the wireless communication apparatus to communicate with the opposing apparatus generates (recovers) a transmit clock based on a master clock to be a reference and performs transmission processing based on the transmit clock, and

the wireless communication apparatus not selected as the wireless communication apparatus to communicate with the opposing apparatus generates (recovers) a transmit clock based on the master clock but will not perform the transmission processing based on the transmit clock.

(3) The wireless transmission system according to (1) or (2), wherein

the first wireless communication apparatus and the second wireless communication apparatus comprises:
input means for inputting the master clock to be the reference from outside;
transmit clock generating means for generating (recovering) the transmit clock based on the master clock;
transmission processing means for performing the transmission processing based on the transmit clock;
reception processing means for performing reception processing;
receive clock generating means for generating (recovering) a receive clock;
failure detecting means for detecting the failure information from information that has been subjected to the reception processing by the reception processing means; and
notification means for notifying the selecting apparatus of an occurrence of a failure when the failure information is detected.
   (4) The wireless transmission system according to (3), wherein

the failure detecting means further detects that a failure has occurred in the wireless communication apparatus including the corresponding failure detecting means, and

the notification means notifies the selecting apparatus of an occurrence of the failure in the wireless communication apparatus including the corresponding notification means.

(5) The wireless transmission system according to any one of (1) to (3), wherein the selecting apparatus comprises:

selecting means for selecting the first wireless communication apparatus or the second wireless communication apparatus as the wireless communication apparatus to communicate with the opposing apparatus; and

switch control means for performing control to switch the wireless communication apparatus to communicate with the opposing apparatus selected by the selecting means, in response to the notification from the wireless communication apparatus not selected by the selecting means as the wireless communication apparatus to communicate with the opposing apparatus.

(6) The wireless transmission system according to (5), wherein

the selecting apparatus further comprises clock generating means for generating a master clock to be the reference, and

the selecting means outputs the master clock to both of the first wireless communication apparatus and the second wireless communication apparatus.

(7) A wireless communication apparatus that is connected to a selecting apparatus for selecting a wireless communication apparatus to communicate with an opposing apparatus positioned opposite with a wireless transmission line therebetween, the wireless communication apparatus comprising:

reception processing means for performing reception processing;

receive clock generating means for generating (recovering) a receive clock;

detecting means for detecting that a failure has occurred; and

notification means for performing notification that the failure has occurred, wherein

when the wireless communication apparatus is not selected as the wireless communication apparatus to communicate with the opposing apparatus,
the detecting means detects failure information indicating that a failure has occurred in the wireless communication apparatus communicating with the opposing apparatus from information that has been subjected to the reception processing by the reception processing means, and
the notification means notifies the selecting apparatus, when the failure information is detected, that the failure has occurred in the wireless communication apparatus communicating with the opposing apparatus.
   (8) The wireless communication apparatus according to (7), further comprising:

input means for inputting a master clock to be a reference from outside;

transmit clock generating means for generating (recovering) a transmit clock based on the master clock; and

transmission processing means for performing transmission processing based on the transmit clock, wherein

when the wireless communication apparatus is not selected as the wireless communication apparatus to communicate with the opposing apparatus,
the input means inputs the master clock referred by the wireless communication apparatus communicating with the opposing apparatus, and the transmit clock generating means generates (recovers) a transmit clock based on the master clock input by the input means but the transmission processing means will not perform the transmission processing based on the transmit clock.
   (9) The wireless communication apparatus according to (7) or (8), wherein

the detecting means further detects that a failure has occurred in the wireless communication apparatus including the corresponding detecting means, and

the notification means notifies the selecting apparatus that the failure has occurred in the wireless communication apparatus including the corresponding notification means.

(10) A wireless transmission method comprising steps of:

selecting, from a plurality of wireless communication apparatuses including a wireless communication function, a wireless communication apparatus to communicate with an opposing apparatus, the opposing apparatus being positioned opposite with a wireless transmission line therebetween;

receiving, by a wireless communication apparatus not selected as the wireless communication apparatus to communicate with the opposing apparatus, a signal transmitted from the opposing apparatus;

detecting failure information in the received signal, the failure information indicating that a failure has occurred in the wireless communication apparatus communicating with the opposing apparatus;

performing notification when the failure information is detected, the notification indicating that the failure has occurred in the wireless communication apparatus communicating with the opposing apparatus; and

switching, in response to the notification, the wireless communication apparatus to communicate with the opposing apparatus.

Although the present invention has been explained with reference to the exemplary embodiments, the present invention is not limited by above. Various modifications, obvious to those in the art, can be made to the configurations and details of the present invention within the scope of the invention.

The present application claims priority rights of and is based on Japanese Patent Application No. 2011-116974 filed on May 25, 2011 in the Japanese Patent Office, the entire contents of which are hereby incorporated by reference.

### INDUSTRIAL APPLICABILITY

The present invention can be used to realize high communication quality in various wireless communication networks such as a mobile communication system.

### REFERENCE SIGNS LIST

10, 20, 30, 40 WIRELESS COMMUNICATION APPARATUS
11, 21, 31, and 41 COMMUNICATION PROCESSING UNIT
12, 22, 32, and 42 WIRED TRANSFER UNIT
13, 23, 33, and 43 TRANSMIT CLOCK RECOVER UNIT
14, 24, 34, and 44 TRANSMISSION PROCESSING UNIT
15, 25, 35, and 45 RECEPTION PROCESSING UNIT
16, 26, 36, and 46 RECEIVE CLOCK PROCESSING UNIT
17, 27, 37, and 47 ALARM DETECTING UNIT
50 and 60 SELECTING APPARATUS
51 and 61 SWITCHING UNIT
52 and 62 SWITCH CONTROL UNIT
53 and 63 MASTER CLOCK UNIT
810, 820, 830, and 840 WIRELESS COMMUNICATION APPARATUS
850 and 860 SELECTING APPARATUS
1000 and 2000 WIRELESS TRANSMISSION SYSTEM

1. A wireless transmission system comprising:
a first wireless communication apparatus and a second wireless communication apparatus including a wireless communication function; and
a selecting apparatus that selects the first wireless communication apparatus or the second wireless communication apparatus as a wireless communication apparatus to communicate with an opposing apparatus, the opposing apparatus being positioned opposite with a wireless transmission line therebetween, wherein
the second wireless communication apparatus
receives a signal transmitted from the opposing apparatus when the selecting apparatus selects the first wireless communication apparatus as the wireless communication apparatus to communicate with the opposing apparatus, and
performs notification that a failure has occurred in the first wireless communication apparatus when the second wireless communication apparatus detects failure information indicating that the failure has occurred in the first wireless communication apparatus, and
the selecting apparatus performs switch control to switch the wireless communication apparatus to communicate with the opposing apparatus from the first wireless communication apparatus to the second wireless communication apparatus based on the notification.

2. The wireless transmission system according to claim 1, wherein
between the first wireless communication apparatus and the second wireless communication apparatus,
the wireless communication apparatus selected as the wireless communication apparatus to communicate with the opposing apparatus generates a transmit clock based on a master clock to be a reference and performs transmission processing based on the transmit clock, and
the wireless communication apparatus not selected as the wireless communication apparatus to communicate with the opposing apparatus generates a transmit clock based on the master clock but will not perform the transmission processing based on the transmit clock.

3. The wireless transmission system according to claim 1, wherein
the first wireless communication apparatus and the second wireless communication apparatus comprises:
an input unit that inputs the master clock to be the reference from outside;
a transmit clock generating unit that generates the transmit clock based on the master clock;
a transmission processing unit that performs the transmission processing based on the transmit clock;
a reception processing unit that performs reception processing;
a receive clock generating unit that generates a receive clock;
a failure detecting unit that detects the failure information from information that has been subjected to the reception processing by the reception processing unit; and
a notification unit that notifies the selecting apparatus of an occurrence of a failure when the failure information is detected.

4. The wireless transmission system according to claim 3, wherein
the failure detecting unit further detects that a failure has occurred in the wireless communication apparatus including the corresponding failure detecting unit, and
the notification unit notifies the selecting apparatus of an occurrence of the failure in the wireless communication apparatus including the corresponding notification unit.

5. The wireless transmission system according to claim 1, wherein the selecting apparatus comprises:
a selecting unit that selects the first wireless communication apparatus or the second wireless communication apparatus as the wireless communication apparatus to communicate with the opposing apparatus; and
a switch control unit that performs control to switch the wireless communication apparatus to communicate with the opposing apparatus selected by the selecting unit, in response to the notification from the wireless communication apparatus not selected by the selecting unit as the wireless communication apparatus to communicate with the opposing apparatus.

6. The wireless transmission system according to claim 5, wherein
the selecting apparatus further comprises a clock generating unit that generates the master clock to be the reference, and
the selecting unit outputs the master clock to both of the first wireless communication apparatus and the second wireless communication apparatus.

7. A wireless communication apparatus comprising:
a reception processing unit that performs reception processing;
a receive clock generating unit that generates a receive clock;
a detecting unit that detects that a failure has occurred; and
a notification unit that performs notification that the failure has occurred, wherein
when the wireless communication apparatus is not selected as a wireless communication apparatus to communicate with an opposing apparatus by a selecting apparatus that selects a wireless communication apparatus to communicate with the opposing apparatus positioned opposite with a wireless transmission line therebetween,
the detecting unit detects failure information indicating that a failure has occurred in the wireless communication apparatus communicating with the opposing apparatus from information that has been subjected to the reception processing by the reception processing unit, and
the notification unit notifies the selecting apparatus, when the failure information is detected, that the failure has occurred in the wireless communication apparatus communicating with the opposing apparatus.

8. The wireless communication apparatus according to claim 7, further comprising:
an input unit that inputs a master clock to be a reference from outside;
a transmit clock generating unit that generates a transmit clock based on the master clock; and
a transmission processing unit that performs transmission processing based on the transmit clock, wherein
when the wireless communication apparatus is not selected as the wireless communication apparatus to communicate with the opposing apparatus,
the input unit inputs the master clock referred by the wireless communication apparatus communicating with the opposing apparatus, and the transmit clock generating unit generates a transmit clock based on the master clock input by the input unit but the transmission processing unit will not perform the transmission processing based on the transmit clock.

9. The wireless communication apparatus according to claim 7, wherein
the detecting unit further detects that a failure has occurred in the wireless communication apparatus including the corresponding detecting unit, and
the notification unit notifies the selecting apparatus that the failure has occurred in the wireless communication apparatus including the corresponding notification unit.

10. A wireless transmission method comprising:
selecting, from a plurality of wireless communication apparatuses including a wireless communication function, a wireless communication apparatus to communicate with an opposing apparatus, the opposing apparatus being positioned opposite with a wireless transmission line therebetween;
receiving, by a wireless communication apparatus not selected as the wireless communication apparatus to communicate with the opposing apparatus, a signal transmitted from the opposing apparatus;
detecting failure information in the received signal, the failure information indicating that a failure has occurred in the wireless communication apparatus communicating with the opposing apparatus;
performing notification when the failure information is detected, the notification indicating that the failure has occurred in the wireless communication apparatus communicating with the opposing apparatus; and
switching, in response to the notification, the wireless communication apparatus to communicate with the opposing apparatus
